(19) United States
(12) Patent Application Publication
(10) Pub. No.: US 2013/0337348 A1
(43) Pub. Date: Dec. 19, 2013

(54) ALKALI METAL-AIR FLOW BATTERIES

(71) Applicant: Jian-Ping (Jim) Zheng, Tallahassee, FL (US)

(72) Inventor: Jian-Ping (Jim) Zheng, Tallahassee, FL (US)

(21) Appl. No.: 13/883,404

(22) PCT Filed: Nov. 7, 2011
(86) PCT No.: PCT/US11/59605

§ 371 Date: Sep. 3, 2013

Related U.S. Application Data
(60) Provisional application No. 61/410,520, filed on Nov. 5, 2010.

(51) Int. Cl. H01M 8/22; H01M 4/90; H01M 8/04

(52) U.S. Cl. CPC H01M 8/22; H01M 8/04276; H01M 4/9016
USPC 429/405

(57) ABSTRACT

Alkali metal-air flow battery can include an electrochemical reaction unit and an electrolyte reservoir. The electrolyte reservoir can be fluidly coupled to a cathode electrolyte chamber to allow for circulation of an electrolyte solution from the electrolyte reservoir to the cathode electrolyte chamber. Circulation of the electrolyte solution from the electrolyte reservoir to the cathode electrolyte chamber can be done at a rate sufficient to maintain the solubility of at least one discharge product of a reaction occurring in the cathode section in the electrolyte solution.

### CROSS-REFERENCES TO RELATED APPLICATIONS

This application claims benefit under 35 U.S.C. §119(e) to U.S. Provisional Patent Application Ser. No. 61/410,520, filed on Nov. 5, 2010, which is hereby incorporated by reference in its entirety.

### STATEMENT REGARDING FEDERALLY SPONSORED RESEARCH OR DEVELOPMENT

This invention was made with government support under a federally sponsored research project entitled, “Research and Development on Some Critical Issues for High Energy and Power Densities, and Good Lifespan of Li-air Batteries” sponsored by US Army CERDEC; and a federally sponsored research projected entitled, “Optimization of specific capacity of Li-Air Batteries Using Carbon Nanotube Sheets as Air Electrodes” sponsored by US Army CERDEC. The government has certain rights in the invention.

### THE NAMES OF THE PARTIES TO A JOINT RESEARCH AGREEMENT

The present invention was not made in the course of a joint research agreement.

### BACKGROUND OF THE INVENTION

1. Field of the Invention

The invention relates generally to alkali metal-air batteries and more specifically to alkali metal-air flow batteries.

2. Description of the related art

Alkali metal-air batteries, and in particular, lithium (Li)-air batteries have attracted much attention due to their relatively low cost and extremely high specific capacity. In a conventional non-aqueous Li-air battery the Li anode is electrochemically coupled to atmospheric oxygen (O₂) through an air cathode. During discharge, Li ions flow from the anode through an electrolyte and react with the O₂ at the cathode to form Li₂O, Li₂O₂, or other Li compounds. The reason for the high specific capacity is that the Li anode electrode is usually light and the cathodic reactant (O₂) is taken from the air. The theoretical maximum capacity of Li-air batteries is determined assuming complete electrochemical oxidation of the metallic Li anode. The theoretical specific capacity of Li is 3862 mAh/g², which is much higher than that of any other type of electrode materials used in advanced Li-ion or Li-polymer batteries. Considering an operational voltage of 2.9-3.1 V, the theoretical maximum energy densities of Li-air batteries have been calculated based on charge balance and are in the range of 1300-2600 Wh/kg, depending on the type of the electrolytes used; these values are not only much higher than those of any advanced batteries, but also higher than that of fuel cells.

Although Li-air batteries have an extremely large theoretical energy density, they suffer from several severe drawbacks:
(1) The Li₂O₂/Li₂O discharge product in non-aqueous electrolytes and the LiOH.H₂O product in aqueous electrolytes deposit on the air side of the electrode reducing the pore size and limiting the access of the O₂ in the cathode. The discharge products deposit mostly near the air side of the electrode because the O₂ concentration is higher on this side. This inhomogeneous deposition of the reaction products limits the usage of cathode volume, which limits the maximum capacity and the energy density of the battery;
(2) both the cyclability and the energy efficiency of Li-air batteries are poor due to the lack of effective catalysts to convert the solid Li₂O₂/Li₂O or LiOH.H₂O discharge products into Li ions; and
(3) both the current density and the power density of Li-air batteries are much lower compared to those of conventional batteries.

### BRIEF SUMMARY OF THE INVENTION

One embodiment relates to an alkali metal-air flow battery system comprising an electrochemical reaction unit and an electrolyte reservoir. The electrochemical reaction unit can include a lithium ion conductive membrane disposed between an anode section and a cathode section. The anode section can include an anode comprising one or more alkali metals, and an anode electrolyte chamber adjacent to the anode and the lithium ion conductive membrane. The cathode section can include an air electrode comprising porous carbon, and a cathode electrolyte chamber adjacent to the air electrode and the Li ion conductive membrane. The electrolyte reservoir can be fluidly coupled to the cathode electrolyte chamber to allow for circulation of an electrolyte solution from the electrolyte reservoir to the cathode electrolyte chamber.

The one or more alkali metals can be selected from the group consisting of lithium (Li), sodium (Na), potassium (K), rubidium (Rb), cesium (Cs), francium (Fr), and combinations thereof. The electrolyte solution can comprise a salt selected from the group consisting of diluted lithium hydroxide (LiOH), Acetic acid (CH₃COOH), Chloric Acid (HClO₃), Perchloric acid (HClO₄), Formic acid (HCOOH), Nitric acid (HNO₃), Salicylic acid (C₆H₄(OH)COOH), Sulfuric acid (H₂SO₄), Hydrobromic acid (HBr), Hydrochloric acid (HCl), Thiocyanic acid (HSCN), and combinations thereof.

A thickness of the air electrode can be determined by an oxygen diffusion length, expressed as:

$$λ = 2 F {ɛ}^{1.5} \frac{{c}_{{O}_{2}}^{0} {D}_{{O}_{2}}}{I}$$

where, ε is a porosity of the air electrode, c_{O}_{₂}⁰ is an oxygen concentration in the electrolyte solution near the air electrode, D_{O}_{₂} is an effective diffusion constant of the oxygen, and I is a discharge current density. For example, in some embodiments, the thickness of the air electrode can be from 10 microns to 1 cm.

An electrocatalyst, such as α-MnO₂ nanoparticles, can be distributed at a surface of the one or more air electrodes.

Another embodiment relates to a method of operating the alkali metal-air flow battery system described according to the previous embodiment. The method can comprise circulating an electrolyte solution from the electrolyte reservoir to the cathode electrolyte chamber. The method can further comprise re-circulating the electrolyte solution from the cathode electrolyte chamber to the electrolyte reservoir. The circulation of the electrolyte solution from the electrolyte reservoir to the cathode electrolyte chamber can be at a rate sufficient to maintain the solubility of at least one discharge product of a reaction occurring in the cathode section in the electrolyte solution.

During a discharge process of the alkali metal-air battery system, the method can comprise circulating the electrolyte solution from the electrolyte reservoir to the cathode electrolyte chamber at a rate determined by a relationship between a current produced by the electrochemical reaction unit and an alkali metal-ion concentration in the electrolyte reservoir. The relationship can be given by an expression:

$$Flow rate {\vert}_{discharge} = \frac{I}{F ( {m}_{sol} - m )} ,$$

where, I is the current, F is the Faraday constant, which is 96,485 C/mol, mₛₒₗ is the maximum molar concentration (solubility) of the electrolyte, and m is the molar concentration of the alkali metal-ion in the electrolyte reservoir.

During a charging process of the alkali metal-air battery system, the method can comprise circulating the electrolyte solution from the electrolyte reservoir to the cathode electrolyte chamber at a rate determined by an expression:

$$Flow rate {\vert}_{charge} = \frac{I}{Fm} ,$$

where, I is the current, F is the Faraday constant, which is 96,485 C/mol, and m is the molar concentration of the alkali metal-ion in the electrolyte reservoir.

Another embodiment relates to a method comprising flowing an electrolyte solution across an air electrode of a alkali metal-air battery. The electrolyte solution can comprise diluted LiOH and the alkali metal can be Li. The flowing can be done at a flow rate sufficient to maintain the concentration of LiOH in the electrolyte solution at less than 12.5 g of LiOH per 100 g of water. The flowing can collects LiOH discharge product formed at the air electrode.

### BRIEF DESCRIPTION OF THE DRAWINGS

These and other features, aspects, and advantages of the present invention will become better understood with reference to the following description and appended claims, and accompanying drawings where:

FIG. 1 shows a schematic illustration of a rechargeable Li-air battery using dual electrolytes;

FIG. 2 shows a schematic illustration of a Li-air flow battery;

FIG. 3 shows a schematic illustration of an electrochemical reaction unit configuration;

FIG. 4 shows a schematic illustration of an electrode configuration of an electrochemical reactor; and

FIG. 5 is a plot showing the cell voltage vs. specific discharge capacity for cells using different cathodes.

It should be understood that the various embodiments are not limited to the arrangements and instrumentalities shown in the drawings.

### DETAILED DESCRIPTION OF THE INVENTION

The present invention may be understood more readily by reference to the following detailed description of preferred embodiments of the invention as well as to the examples included therein. All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure.

Various embodiments relate to rechargeable Li-air batteries. Such batteries can have an aqueous electrolyte in the cathode and produce a water soluble discharge product. The charging process can be achieved through an oxygen evolution process. The rechargeable Li-air batteries can be conceptually divided into two categories depending on the basic or acidic nature of the electrolytes used in cathode electrodes. These two conceptual categories will be discussed in the following sections, A and B.

A. Rechargeable Li-Air Batteries Using Basic Electrolyte

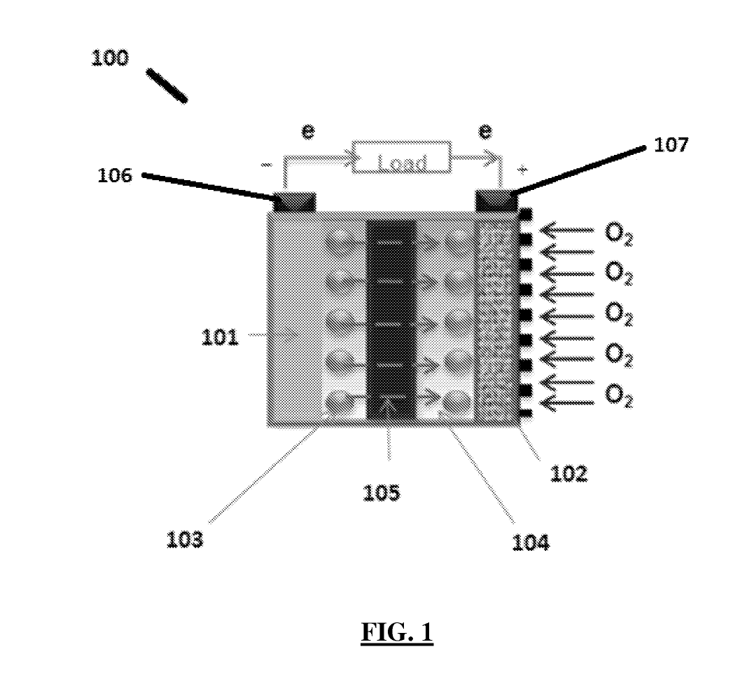

Referring to FIG. 1, a rechargeable alkali metal-air battery 100, according to various embodiments, is shown. In the rechargeable alkali metal-air battery 100, an alkali metal, such as Li metal can be used as the anode 101 due to its high specific capacity and low potential, while porous carbon can be used as an air electrode 102. The air electrode 102 can comprise a porous carbon material, such as carbon nanotube papers (buckypapers), which were shown to increase the high specific capacity and to decrease the electrical resistance of Li-air batteries. In addition, since buckypapers are free-standing thin films consisting of carbon nanotubes and/or carbon nanofibers held together by van der Waals forces without any chemical binders, they can increase the chemical and mechanical stability of the cell. A cathode current collector 107 can be coupled to the air electrode 102. The cathode current collector 107 can comprise any suitable conductive material, such as a Ni mesh, which has a good chemical stability in basic electrolyte solutions.

A non-aqueous electrolyte 103 can be used in the anode and an aqueous electrolyte 104 such as diluted LiOH solution in the cathode electrodes. A solid Li-ion conductive membrane 105 (such as Li-ion conducting glass-ceramic, LIC-GC) can be used between the anode and the air electrodes. An anode current collector 106 can be coupled to the anode 101. The anode current collector 106 can be any suitable conductive material, such as a copper (Cu) foil.

The conductive membrane 105 can have not only a good conductivity for Li ions, but also a good chemical stability in both non-aqueous and diluted LiOH solutions. The conductive membrane 105 should also have the ability to isolate the two electrolytes to prevent or minimize mixing.

The overall reaction for a Li-air flow battery, according to various embodiments, can be expressed as:

4Li+O₂+2H₂O⇄4LiOH (¹)

The maximum concentration of Li⁺ and OH⁻ ions can be determined by the solubility of the LiOH in water, which is 12.5 g of LiOH/100 g of water (H₂O) at 25° C. When the Li⁺ and OH⁻ concentrations reach this value, LiOH will precipitate, thus filling up the porous volume in the air electrode 102 and eventually blocking the O₂ channels and stopping the discharge process. According to various embodiments, the solid deposition on the air electrode 102 of the LiOH discharge product is reduced or prevented by taking measures to ensure that the Li⁺ and OH⁻ concentrations remain below 12.5 g of LiOH/100 g of water (H₂O) at 25° C. More specifically, according to various embodiments, the solid deposition of the LiOH discharge product can be reduced or prevented by introducing additional H₂O. Considering the solubility of LiOH in H₂O, 1 mol LiOH needs at least x mol of H₂O:

$$x = \frac{\frac{100 g}{{M}_{LiOH}}}{\frac{12.5 g}{{M}_{{H}_{2} O}}} = \frac{100 g \times 23.94 g \text{/} mol}{12.5 \times 18 g \text{/} mol} = 10.64 mol \qquad ( 2 )$$

where M_{LiOH} and M_{H}_{₂}_{O} are the molecular weights of LiOH and H₂O, respectively. Therefore, the overall mass balance can be expressed as:

Li+0.50₂+0.5H₂O+10.64H₂O H Li⁺+OH⁻+10.64H₂O (3)

The specific capacity excluding O₂ can be computed as:

$$\begin{matrix}{c}_{P} = \frac{F}{{M}_{Li} + 0.5 {M}_{{H}_{2} O} + 10.64 {M}_{{H}_{2} O}} \\ = \frac{96485 C \text{/} mol}{6.94 g \text{/} mol + 11.14 \times 18 g \text{/} mol} \\ = 465 C \text{/} g = 129 mAh \text{/} g .\end{matrix} \qquad ( 4 )$$

The operational voltage is assumed to be V₀=3.69 V; therefore, the estimated energy density of the system (excluding O₂) is:

ε=cₚVₒ=477 Wh/kg (5)

The weight ratio of active materials of Li and H₂O can be determined by 1 mol Li vs. 11.14 mol H₂O as shown in Eqn. (4) and is Li/H₂O=3.3/96.7 in the battery. The weight of the H₂O dominates in the total weight of the battery. The above energy density is calculated based on only the Li metal and the electrolytes (H₂O), and is much lower than the theoretical limitation of conventional Li-air batteries with solid discharge products for using either non-aqueous or dual electrolytes. Considering the other necessary materials such as carbon in the cathode electrode, current collectors, electrolyte membrane, and packaging, the energy density of rechargeable Li-air batteries is not much greater or perhaps slightly less than that of alternative Li-ion batteries.

More specifically, the energy density expressed in Eqn. (5) was estimated based on only active materials such as anode and cathode materials. If the mass of the carbon in the air electrode, current collector, package materials, and small pumps is included, then the estimated energy density of Li-air flow battery is 60% of E, and is about 250 Wh/kg.

The power density of Li-air batteries is comparable to the one of Li-air batteries and is expected to be much lower than that of Li-ion batteries since it is determined by the O₂ solubility and diffusivity in the electrolyte. From Eqn. (1), O₂ evolves during the charge process.

In order to maximize the energy efficiency of Li-air batteries, various embodiments distribute an electrocatalyst in the air electrode 102 in order to reduce the O₂ evolution potential. The specific capacity and energy density calculated based on Eqns. (4) and (5) excluded the O₂ from air. The specific capacity and energy density including O₂ will be slightly lower due to the total weight increasing during the discharge process, which was discussed previously.

B. Rechargeable Li-Air Batteries Using Acidic Electrolyte

From Eqn. (1), it can be seen that the discharge process consumes H₂O. Unlike in batteries with basic electrolyte, the discharge process in batteries with acidic electrolyte does not consume the water, but produces water as a result of the reaction in the cathode electrode. The overall electrochemical reaction in batteries with acetic acid (CH₃COOH) solution as the electrolyte can be expressed as follows:

4Li+O₂+4CH₃COOH⇄4CH₃COOLi+2H₂O (6)

The solubility of the CH₃COOLi discharge product in H₂O is 45 g CH₃COOLi in 100 g H₂O. Each mole of CH₃COOLi needs at least 8.15 mol of H₂O in order to avoid solid deposition in the cathode. Therefore, the specific capacity of the battery excluding O₂ can be calculated as:

$$\begin{matrix}{c}_{P} = \frac{F}{{M}_{Li} + {M}_{{C}_{2} {H}_{4} {O}_{2}} + 7.65 {M}_{{H}_{2} O}} \\ = \frac{96485 C \text{/} mol}{6.94 g \text{/} mol + 60.05 g \text{/} mol + 7.65 \times 18 g \text{/} mol} \\ = 131 mAh \text{/} g ,\end{matrix} \qquad ( 7 )$$

where M_{C}_{₂}_{H}_{₄}_{O}_{₂} is the molar mass of CH₃COOH. The maximum energy density is:

ε=cₚVₒ=483 Wh/kg (8)

This value is close to that obtained for batteries using basic electrolyte. The mass ratio of active materials of Li, CH₃COOH, and H₂O can be determined by 1 mol Li/1 mol CH₃COOH/7.65 mol H₂O as shown in Eqn. (7) and is Li/CH₃COOH/H₂O=3.4/29.3/67.3. The weight of H₂O still dominates in the total weight of the battery. The theoretical energy density for Li-air batteries using different acidic electrolytes can also be estimated using a procedure similar to the one presented in the previous section.

Table I lists some possible Li-air batteries using different electrolytes in the air cathode.

TABLE I
Summary of Li-air batteries using different electrolytes in cathode and the solubility of discharge products

| | | | | Solu- | Molar |
|---|---|---|---|---|---|
| | Molar | | | bility | Mass of |
| Salt in | Mass | | Discharge | (g/100 g | Product |
| Electrolyte | (g/mol) | Overall Reaction Equation | Product | H₂O) | (g/mol) |
| Diluted LiOH | 23.95 | 4Li + O₂ + 2H₂O [symbol] 4LiOH | LiOH | 12.5 | 23.95 |
| Acetic acid | 60.05 | 4Li + O₂ + 4CH₃COOH [symbol] 4CH₃COOLi + 2H₂O | CH₃COOLi | 45 | 65.99 |
| (CH₃COOH) | | | | | |
| Chloric Acid | 84.46 | 4Li + O₂ + 4HClO₃ [symbol] 4LiClO₃ + 2H₂O | LiClO₃ | 459 | 90.40 |
| (HClO₃) | | | | | |
| Perchloric acid | 100.46 | 4Li + O₂ + 4HClO₄ [symbol] 4LiClO₄ + 2H₂O | LiClO₄ | 58.7 | 106.40 |
| (HClO₄) | | | | | |
| Formic acid | 46.03 | 4Li + O₂ + 4HCOOH [symbol] 4HCOOLi + 2H₂O | HCOOLi | 39.3 | 51.97 |
| (HCOOH) | | | | | |
| Nitric acid | 63.01 | 4Li + O₂ + 4HNO₃ [symbol] 4LiNO₃ + 2H₂O | LiNO₃ | 102 | 68.95 |
| (HNO₃) | | | | | |
| Salicylic acid | 138.12 | 4Li + O₂ + 4C₆H₄(OH)COOH [symbol] | C₆H₄(OH) | 133.3 | 144.06 |
| (C₆H₄(OH)COOH) | | 4C₆H₄(OH)COOLi + 2H₂O | COOLi | | |
| Sulfuric acid | 98.08 | 4Li + O₂ + 2H₂SO₄ [symbol] 2Li₂SO₄ + 2H₂O | Li₂SO₄ | 34.2 | 109.96 |
| (H₂SO₄) | | | | | |
| Hydrobromic | 80.91 | 4Li + O₂ + 4HBr [symbol] 4LiBr + 2H₂O | LiBr | 181 | 86.85 |
| acid (HBr) | | | | | |
| Hydrochloric acid | 36.46 | 4Li + O₂ + 4HCl [symbol] 4LiCl + 2H₂O | LiCl | 84.5 | 42.40 |
| (HCl) | | | | | |
| Thiocyanic acid | 59.09 | 4Li + O₂ + 4HSCN [symbol] 4LiSCN + 2H₂O | LiSCN | 120 | 65.03 |
| (HSCN) | | | | | |

The overall chemical reactions during the charge/discharge, and solubility of discharge products are all included in Table I.

The minimum amount of H₂O needed for dissolving 1 mol of Li discharge product, the specific capacity, and the maximum energy density are calculated based on Eqns. (6)-(8) and are listed in Table II.

TABLE II
Summary of specific capacities and energy densities for Li-air batteries using
different electrolytes, and weight ratios of active materials in batteries

| | Minimum | Additional | | Energy | |
|---|---|---|---|---|---|
| | Amount H₂O for | H₂O for 1 mol | Specific | Density at | |
| Salt in | 1 mol of Product | of Product | Capacity | OCV = 3.69 V | Mass Ratio |
| Electrolyte | (mol) | (mol) | (mAh/g) | (Wh/kg) | (Li/Salt/Water) |
| Diluted LiOH | 11.14 | 11.14 | 129.19 | 476.70 | 3.35/0/96.65 |
| Acetic acid | 8.15 | 7.65 | 130.97 | 483.28 | 3.39/29.35/67.26 |
| (CH₃COOH) | | | | | |
| Chloric Acid | 1.09 | 0.59 | 262.51 | 968.68 | 6.80/82.73/10.47 |
| (HClO₃) | | | | | |
| Perchloric acid | 10.07 | 9.57 | 95.83 | 353.63 | 2.48/35.92/61.60 |
| (HClO₄) | | | | | |
| Formic acid | 7.35 | 6.85 | 152.10 | 561.24 | 3.94/26.12/69.94 |
| (HCOOH) | | | | | |
| Nitric acid | 3.76 | 3.26 | 208.49 | 769.33 | 5.40/49.02/45.58 |
| (HNO₃) | | | | | |
| Salicylic acid | 6.00 | 5.50 | 109.78 | 405.10 | 2.84/56.58/40.58 |
| (C₆H₄(OH)COOH) | | | | | |
| Sulfuric acid | 17.86 | 17.36 | 72.73 | 268.37 | 1.88/13.31/84.81 |
| (H₂SO₄) | | | | | |
| Hydrobromic acid | 2.67 | 2.17 | 211.31 | 779.74 | 5.47/63.79/30.74 |
| (HBr) | | | | | |
| Hydrochloric acid | 2.79 | 2.29 | 316.88 | 1169.29 | 8.20/43.11/48.69 |
| (HCl) | | | | | |
| Thiocyanic acid | 3.01 | 2.51 | 240.97 | 889.19 | 6.24/53.13/40.63 |
| (HSCN) | | | | | |

From Table II, it can be seen that the electrolyte in the cathode including salt and H₂O dominates the weight of the battery and, in general, the higher the solubility of the discharge product the higher the energy density of the battery. From Table II, it can also be seen that the highest energy density can be achieved by using strong acid solutions such as HCl and HClO₃ solutions due to the high solubility of discharge products. However, using strong acid solutions can cause some practical problems such as stability of the electrode and catalyst materials, current collectors, and membrane.

The different electrolytes listed in Tables I and II can be used in duel-electrolytes rechargeable Li-air batteries alone or in combination with one another.

In addition to the Li metal anode electrode, another important electrode in Li-air batteries is the electrically conductive air electrode (cathode). The thickness of the cathode electrode can be thicker than the oxygen diffusion length, which can be expressed as:

$$λ = 2 F {ɛ}^{1.5} \frac{{c}_{{O}_{2}}^{0} {D}_{{O}_{2}}}{I} \qquad ( 9 )$$

where, ε is the porosity of cathode electrode, c_{O}_{₂}⁰ is the oxygen concentration in the electrolyte near the air side, D_{O}_{₂} is the effective diffusion constant of the oxygen, and I is the discharge current density.

For instance, for a battery operating at a discharge current of 0.1 mA/cm², initial cathode porosity of 75%, external pressure of the atmosphere of 1 atm. air, and O₂ diffusion coefficient of 7×10⁻⁶ cm²/s, the cathode thickness in Li-air batteries should be of the order of λ=60 μm. It can be estimated that when the cross-sectional areas of both anode and cathode are the same, the thickness ratio for the cathode and anode will be as large as 15:1 in order to fully utilize the Li in batteries using either diluted LiOH solution or CH₃COOH/H₂O electrolytes. Therefore, the volume of the cathode will be much greater than that of the anode. In addition to the electrolyte, other necessary materials including porous electrical conductive materials (such as high surface carbon), catalysts, current collectors, and hydrophobic filters are needed.

One of the major disadvantages of Li-air battery is their low power density, which is limited by the oxygen (O₂) concentration and diffusivity in the electrolyte, and by the electrochemical reaction rate. The discharge processes can be explained by looking at the electrochemical reaction rate equation and the oxygen (O₂) concentration inside the air electrode as expressed in Eqn. 10:

$$\begin{matrix}R ( x ) = κɛ ( x ) {C}_{{O}_{2}} ( x ) exp ( \frac{0.5 F}{RT} η ) , {C}_{{O}_{2}} ( x ) \\ = {C}_{{O}_{2} , 0} exp ( - \frac{Ax}{{D}_{{O}_{2 , eff}}} ) ,\end{matrix} \qquad ( 10 )$$

where, κ is a parameter proportional to the reaction rate coefficient, ε(x) is the porosity inside the air electrode, F is the Faraday constant, R is the universal gas constant, T is the absolute temperature, η is the electrode over-potential, C_{O}_{₂}_{,0} is the oxygen (O₂) concentration in air electrode at the air electrode/air interface, A is parameter proportional to the current density, x is the depth from the air electrode/air interface into the air electrode, and D_{O}_{_{2,eff}} is the oxygen (O₂) effective diffusion coefficient.

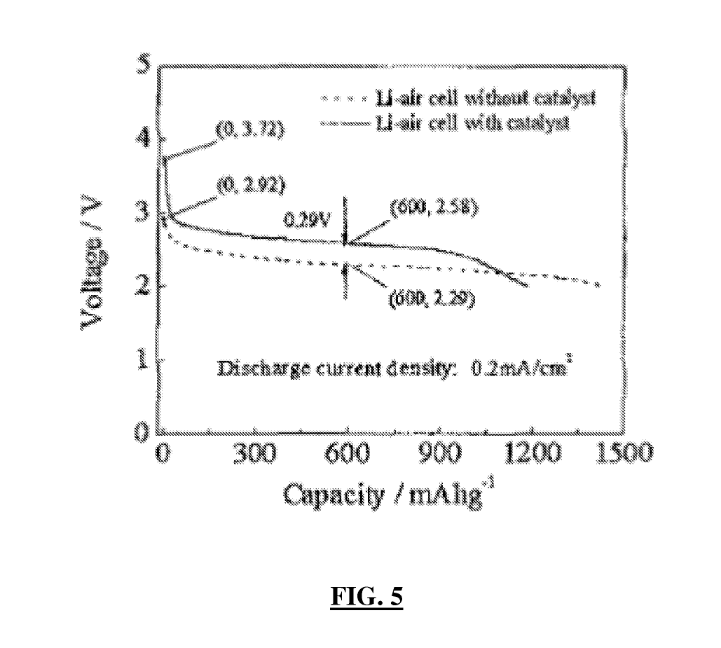

The low discharge current density of Li-air batteries is due to the low oxygen (O₂) concentration and the low reaction rate coefficient. Various embodiments provide air electrodes with desired catalytic functions for promoting oxygen (O₂) reaction and evolution during the discharge and charge, respectively. The catalytic material selection and distribution can influence the reaction rate as well as the current density. According to various embodiments doped-MnO₂ effectively increases the reaction rate coefficient by 250 times and increases the cell voltage in non-aqueouselectrolyte cells as shown in FIG. 5, which plots cell voltage against the specific discharge capacity for Li-Air battery cells with and without a catalyst. As can be seen from the plot the voltage of a Li-Air cell with a catalyst is almost 13% higher than a Li-Air cell without a catalyst at 600 mAhg⁻¹. For oxygen (O₂) evolution during charge, electrocatalysts can be used. For example, α-MnO₂ nanoparticles can be used as electrocatalysts. Any suitable electrocatalyst can be employed. The basic function of catalysts in the air electrode is to reduce the over-potentials due to the electrochemical reaction; therefore, increase the cell voltage during the discharge and decrease the required voltage during the charge in order to reduce the voltage difference during the charge and discharge. The round-trip energy efficiency is defined as the ratio of the cell voltage during the discharge to the required voltage during the charge.

The nanoparticles can have a diameter in a range within a range having a lower limit and/or an upper limit. The range can include or exclude the lower limit and/or the upper limit. The lower limit and/or upper limit can be selected from 2, 2.5, 3, 3.5, 4, 4.5, 5, 5.5, 6, 6.5, 7, 7.5, 8, 8.5, 9, 9.5, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 9100, 9200, 9300, 9400, 9500, 9600, 9700, 9800, 9900, and 10000 nanometers. For example, the nanoparticles can have a diameter of from 2 to 10,000 nanometers.

The energy round-trip efficiency (η) is defined as:

$$η = 1 - \frac{{V}_{charge} - {V}_{discharge}}{{V}_{charge}} = 1 - \frac{Δ V}{{V}_{charge}} = \frac{{V}_{discharge}}{Δ V + {V}_{discharge}}$$

where, V_{charge} and V_{discharge} are cell voltages during discharge and charge, respectively, and ΔV=V_{charge}−V_{discharge} is the voltage difference between charge and discharge, which can also be expressed as:

$$Δ V = \frac{{V}_{discahrge}}{η} - {V}_{discharge}$$

For a discharge voltage of 3.1 V and round-trip efficiency of 75%, the voltage difference between charge and discharge must be controlled within 1.0 V.

According to various embodiments, the structure of Li-air batteries can be adjusted to employ an electrochemical reactor and a fuel (electrolyte) storage as two separate units.

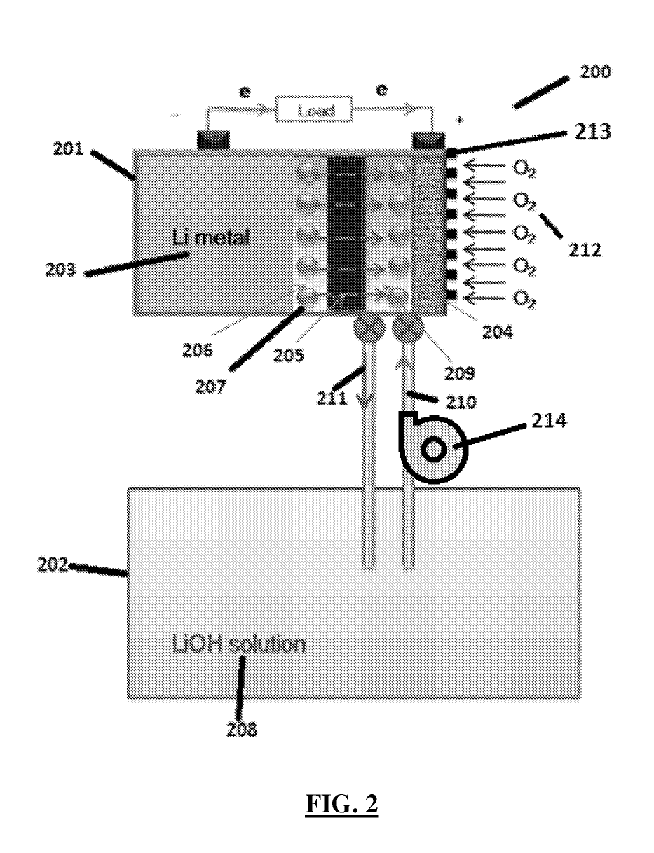

Referring to FIG. 2, an alkali metal-air flow battery system, more specifically, a Li-air flow battery system 200, according to various embodiments of the present invention is illustrated. The Li-air flow battery system 200 can comprise two units: an electrochemical reaction unit 201 and an electrolyte reservoir 202. The electrochemical reaction unit 201 can include an anode section and a cathode section separated by a conductive membrane.

The anode section can include an anode 203, which can comprise an alkali metal, such as Li metal. Li metal is an effective anode component due to its high specific capacity and low potential; however, any suitable metal can be used. For example, any alkali metal can be employed, including lithium (Li), sodium (Na), potassium (K), rubidium (Rb), caesium (Cs), francium (Fr), and combinations thereof.

The cathode section of the electrochemical reaction unit 201 can include one or more air electrodes 204. Each of the one or more air electrodes can comprise porous carbon. Each of the one or more air electrodes can also comprise a porous hydrophobic polymer membrane 213. The porous hydrophobic polymer membrane can comprise a porous fluoropolymer. On example of a porous hydrophobic polymer is a porous polytetrafluoroethylene. The hydrophobic nature of the porous polymer can help to prevent electrolyte leakage from the cathode section of the electrochemical reaction unit 201. The porous nature of the porous hydrophobic polymer can allow atmospheric oxygen 212 to diffuse through the one or more air electrodes 204.

The one or more air electrodes 204 can have a thickness within a range having a lower limit and/or an upper limit. The range can include or exclude the lower limit and/or the upper limit. The lower limit and/or upper limit can be selected from 5, 10, 15, 20, 25, 30, 35, 40, 45, 50, 55, 60, 65, 70, 75, 80, 85, 90, 95, 100, 150, 200, 250, 300, 350, 400, 450, 500, 550, 600, 650, 700, 750, 800, 850, 900, 950, 1000, 2000, 3000, 4000, 5000, 6000, 7000, 8000, 9000, and 10000 microns. For example, the width of one or more air electrodes 204 can be from 10 microns to 1 cm.

In order to maximize the energy efficiency of Li-air batteries, various embodiments distribute an electrocatalyst in the one or more air electrodes 204 in order to reduce the O₂ evolution potential, as discussed above with respect to FIG. 5.

A conductive membrane 205 can be disposed between the anode 203 and the one or more air electrodes 204. The conductive membrane 205 can be a solid Li-ion conductive membrane, a polymer Li-ion conductive membrane, or a mixture of solid/polymer Li-ion conductive membrane. The conductive membrane 205 can have a thickness within a range having a lower limit and/or an upper limit. The range can include or exclude the lower limit and/or the upper limit. The lower limit and/or upper limit can be selected from 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, and 250 microns. For example, the conductive membrane 205 can have a thickness of from 25 to 200 microns.

A first electrolyte solution 206 can be present in an anode electrolyte chamber 207, which can be positioned between the anode 203 and the conductive membrane 205. The anode electrolyte chamber 207 can have a width spanning the distance between the anode 203 and the conductive membrane 205. The width of the anode electrolyte chamber 207 can be within a range having a lower limit and/or an upper limit. The range can include or exclude the lower limit and/or the upper limit. The lower limit and/or upper limit can be selected from 5, 10, 15, 20, 25, 30, 35, 40, 45, 50, 55, 60, 65, 70, 75, 80, 85, 90, 95, 100, 150, 200, 250, 300, 350, 400, 450, 500, 550, 600, 650, 700, 750, 800, 850, 855, 860, 865, 870, 875, 880, 885, 890, 895, 900, 905, 910, 915, 920, 925, 930, 935, 940, 945, 950, 955, 960, 965, 970, 975, 980, 985, 990, 995, and 1000 microns. For example, the width of the anode electrolyte chamber 207 can be from 10 microns to 1 mm. The first electrolyte solution 206 can be an organic electrolyte or any single electrolyte or combination of electrolytes, including those listed in Tables I and II.

The electrolyte reservoir 202 can contain a second electrolyte solution 208. The second electrolyte solution 208 can comprise the same electrolyte or a different electrolyte as the first electrolyte solution 206. The second electrolyte solution 208 can be circulated from the electrolyte reservoir 202 to a cathode electrolyte chamber 209, which can be positioned adjacent to the air electrode 204. The cathode electrolyte chamber 209 can have a width spanning the distance between the one or more air electrodes 204 and the conductive membrane 205. The width of the cathode electrolyte chamber 209 can be within a range having a lower limit and/or an upper limit. The range can include or exclude the lower limit and/or the upper limit. The lower limit and/or upper limit can be selected from 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 9100, 9200, 9300, 9400, 9500, 9600, 9700, 9800, 9900, 9910, 9920, 9930, 9940, 9950, 9960, 9970, 9980, 9990, 10000, 10010, 10020, 10030, 10040, 10050, 10060, 10070, 10080, 10090, 10100, 10200, 10300, 10400, 10500, 10600, 10700, 10800, 10900, 11000, 12000, 13000, 14000, 15000, 16000, 17000, 18000, 19000, 20000, 30000, 40000, 50000, 60000, 70000, 80000, 90000, and 100000 microns. For example, the width of the cathode electrolyte chamber 209 can be from 10 microns to 1 cm.

Circulation of the second electrolyte solution 208 can be achieved via an inlet circulation line 210 and an outlet circulation line 211. The inlet circulation line 210 can be used to deliver the second electrolyte solution 208 from the electrolyte reservoir 202 to the cathode electrolyte chamber 209. A pump 214 or other suitable circulation means can be employed to cause the flow of the electrolyte solution 208. The outlet circulation line 211 can be used to deliver the second electrolyte solution 208 from the cathode electrolyte chamber 209 back to the electrolyte reservoir 202. Any suitable mechanism can be employed to facilitate circulation of the second electrolyte solution 208, such as a pump. The different electrolytes listed in Tables I and II can be used alone or in combination with one another as the second electrolyte solution 208.

The electrolyte in the one or more air electrodes 204 and/or in the cathode electrolyte chamber 209 can be cycled to and from the electrolyte reservoir 202 during the charge and discharge of the battery system 200. During the discharge process, the diluted electrolyte solution 208 in the electrolyte reservoir 202 will reduce the Li ion concentration for preventing the discharge product to reach the solubility limitation and solid deposition in the air electrode; during the discharge (re-charge) process, the electrolyte reservoir 202 will provide Li-ion source to the one or more air electrodes 204.

During the discharge process, the minimum flow rate between the air electrode in the Li-air cell can be determined by Eqn. 11, according to the relationship of the current produced by the electrochemical reactor and the Li-ion concentration in the Li-ion reservoir as follows:

$$Flow rate {\vert}_{discharge} = \frac{I}{F ( {m}_{sol} - m )} \qquad ( 11 )$$

where, I is the current, F is the Faraday constant and equals 96,485 C/mol, mₛₒₗ is the maximum molar concentration (solubility) of the electrolyte, and m is the molar concentration of the electrolyte in the Li-ion reservoir.

The minimum flow rate during charge process can be determined according to Eqn. 12, as follows:

$$Flow rate {\vert}_{charge} = \frac{I}{Fm} \qquad ( 12 )$$

The minimum molar concentration of the electrolyte can be limited by two factors: (1) the ionic conductivity of the electrolyte decreases with decreasing of the molar concentration of the electrolyte; and (2) the flow rate of the electrolyte increases with decreasing of the molar concentration of the electrolyte. The limitation of the lowest molar concentration can be about 0.01 M/L from the battery resistance perspective.

From FIG. 2, it can be seen that the proposed Li-air flow batteries are different from Li-ion, Li-air, and other conventional rechargeable batteries in which the maximum energy storage and power deliverable capability are proportional to the weight of the battery; the proposed Li-air flow battery is more like a fuel cell, in that the energy and power capabilities can be totally separated according to the load requirements. In Li-air flow batteries, the total energy storage is mainly determined by the volume of the Li-ion reservoir (or electrolyte container) and the maximum power capability is determined by the size and electrode configuration of the electrochemical reactor. A minimum amount of Li anode material in the battery can be determined by the weight ratio of active materials as discussed before. Other factors such as conductance of the Li-ion conductive membrane, O₂ solubility and diffusivity can also affect the power capability of Li-air flow batteries. The proposed Li-air flow battery is different from previous proposed rechargeable Li-air battery which is based on a hypothesis that Li metal can be regenerated from LiOH discharge product.

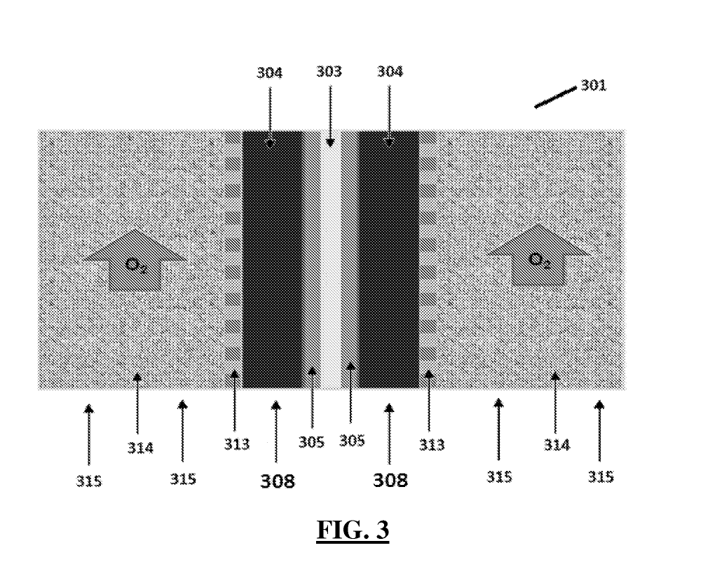

Referring to FIG. 3, a schematic diagram of an electrochemical reaction unit 301 is shown. While the electrochemical reaction unit 301 has a different structural configuration than electrochemical reaction unit 201, all features of reaction unit 201 can be employed in reaction unit 301 and vice versa. The electrochemical unit 301 can have an anode 303. As described above, the anode 303 can comprise an alkali metal, such as lithium metal.

One or more conductive membranes 305 can be disposed adjacent to the anode 303 or adjacent to an anode electrolyte chamber (not shown), which can be positioned between the anode 303 and the conductive membrane 305.

One or more air electrodes 304 can be positioned adjacent to the one or more conductive membranes 305. The conductive membrane 305 can be conductive to alkali metal ions. For example the conductive membrane 305 can be a solid Li-ion conductive membrane. The one or more air electrodes 304 can comprise porous carbon. A cathode electrolyte chamber (not shown), can be positioned between the air electrode 304 and the conductive membrane 304. A second electrolyte solution 308 can be circulated through an electrolyte chamber or directly through the one or more air electrodes, provided that the one or more air electrodes have sufficient porosity so as not to overly restrict the flow of the second electrolyte solution 308. The electrolyte solution can be circulated to and from an electrolyte reservoir (not shown). The different electrolytes listed in Tables I and II can be used alone or in combination with one another as the second electrolyte solution 308.

A porous hydrophobic polymer membrane 313 can be positioned adjacent to the one or more air electrodes 304. As discussed above, the porous hydrophobic polymer membrane 313 can comprise a porous fluoropolymer, such as polytetrafluoroethylene. Air channels 314 can be positioned adjacent to the porous hydrophobic polymer membrane 313. Atmospheric oxygen 315 can flow through the air channels 314.

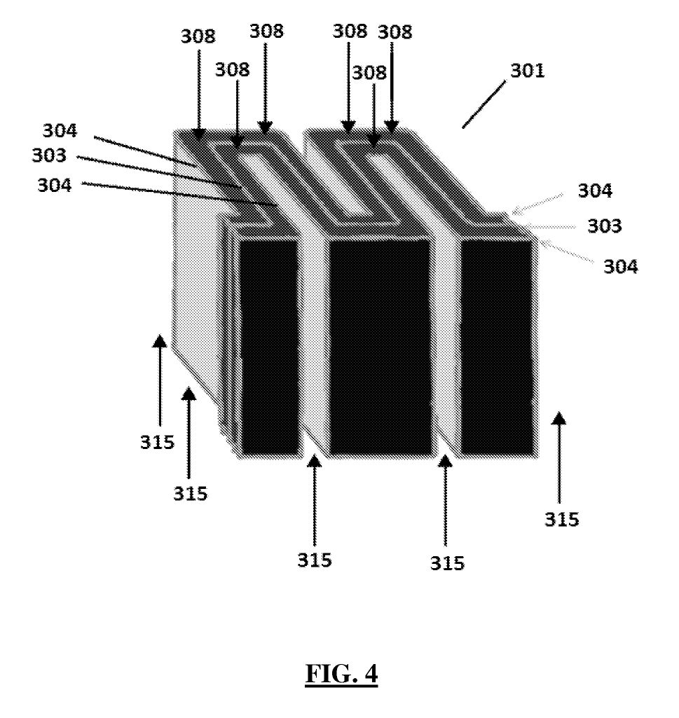

Referring to FIG. 4, a schematic perspective view of the electrochemical reaction unit 301 is shown. The electrochemical reaction unit 301 can be arranged in a serpentine configuration. Any configuration that allows atmospheric oxygen 315 to flow through air channels 314, and the second electrolyte solution 308 to flow between the conductive membrane 304 and the anode 303 can be employed.

Li-air flow batteries have many advantages compared to other electric energy storage batteries used in grid scale applications, including lower cost, higher energy density, better cyclability, lower losses, and easier scale-up. In fact, the Li-air flow batteries are particularly suited for large-scale grid applications by virtue of being cost effective, having a large energy density, and having a large cycle life compared to other electrical energy storage systems for grid applications.

The Li-air flow batteries, according to various embodiments can have a significant impact on the grid-scale energy storage for at least four reasons.

First, the cost of Li-air flow batteries can be significantly lower than other batteries.

Second, the energy density of Li-air flow batteries can be above 250 Wh/kg, which is much higher than that of existing flow, liquid-metal, or advanced Li-ion batteries. The theoretical energy density of Li-air flow batteries is the same as that of rechargeable Li-air batteries as discussed above, and is determined by the electrochemical reaction equation (e.g. Eqns. (1) and (6)) and solubility of the discharge product; however, the discharge power density of these batteries is mainly determined by the oxygen solubility and diffusivity, as can be determined by a physics-based model.

Since, theoretically, an energy density as high as 250 Wh/kg can be achieved from Li-air flow batteries, various embodiments provide a revolutionary new technology to achieve the energy, cost, and cycle life of pumped hydropower (<$100/kWh and >5000 cycles) for grid-scale electrical energy storage. In contrast, the metal flow batteries including zinc-bromide, vanadium redox, and sodium-sulfur flow batteries, as well as lead-acid batteries currently available on the market for grid electrical energy storage applications; however, the price is much higher than $100/kWh, and cycle life is poor.

The theoretical energy densities of rechargeable Li-air batteries with no solid deposition during charge/discharge are estimated according to the mass balance equation, and are 140-1100 Wh/kg which is lower than 2600 Wh/kg for primary Li-air batteries with solid discharge product. These values are obtained based on the weight of only active materials, however, other materials such as current collectors, membranes, and package materials should also be considered for a practical battery. A significant difference between rechargeable Li-air batteries and primary Li-air batteries is that no solid discharge products deposit in the air electrode in rechargeable Li-air batteries.

Third, Li-air flow batteries are different from conventional batteries in which the maximum energy storage and power deliverable are proportional to the weight of the battery. To the contrary, Li-air flow batteries, according to various embodiments, are somewhat similar to fuel cells, in that the energy and power capabilities can be totally separated according to the load requirements. Indeed, in Li-air flow batteries, according to various embodiments, the total energy storage is determined by the volume of the Li-ion reservoir (or LiOH solution container) and the maximum power capability is determined by the size of the electrochemical reactor. In other words, Li-air flow batteries, according to various embodiments, separate the maximum energy storage and power capabilities, allowing the energy and power densities to be mainly determined by the volume of the electrolyte reservoir and the electrochemical reactor, respectively.

Fourth, the manufacture, shipment, and installation weight of Li-airflow batteries, according to various embodiments, is low, because only the reactor, which accounts for <20% of the total weight of the battery, needs to be pre-installed. The major weight of the battery is water, which can be introduced in the battery on the site, after the installation. The cost of Li-air flow batteries can be significantly lower than that of Li-ion batteries. The manufacturing costs, shipment costs, and installation weight of Li-air flow batteries are also low, because only the Li metal and the thin cathode, which is less than 10% of the total weight of the battery electrode, need to be pre-installed. The major weight of the battery is the weight of the electrolyte (e.g. using H₂O in basic electrolyte), which can be easily obtained and introduced in the battery after it is installed on site.

### EXAMPLE

A 1 kWh Li-air flow battery can be produced according to the following specifications. The electrochemical reaction unit can comprise an anode and a cathode. The dimensions of electrochemical reaction unit will depend on the maximum power of the Li-air flow battery. For a 1 kWh Li-air flow battery, the electrochemical reaction unit can be about 10 cm (height)×10 cm (width)×4 cm (thick), and can comprise a 200 μm anode electrode membrane, a 50 μm carbon cathode electrode, a 500 μm porous polytetrafluoroethylene membrane, a 50 μm air flow channel, and a 1 mm for Li metal anode.

The anode of the electrochemical reaction unit can comprise a lithium (Li) metal foil. The Li metal foil can be 200-300 μm-thick and provide sufficient Li material for 1 kWh. A copper (Cu) foil can be used as the current collector for the anode. For a 1 kWh Li-air flow system, the electrode size is about 750 cm².

The cathode of the electrochemical reaction unit can comprise an air electrode. The cathode air electrode can comprise one or more buckypapers, which were shown to increase the high specific capacity and to decrease the electrical resistance of Li-air batteries. In addition, since buckypapers are free-standing thin films consisting of carbon nanotubes and/or carbon nanofibers held together by van der Waals forces without any chemical binders, they increase the chemical and mechanical stability of the cell. A Ni mesh can be used as current collector for the cathode air electrode due to its chemical stability in base solutions.

The Li-air flow battery can also comprise an electrolyte reservoir, which can be a plastic container, capable of holding an electrolyte solution, such as a LiOH solution. The volume of the plastic container can be approximately 2.3 L, allowing a maximum Li-ion storage of about 1 kWh.

Beneficial results can be obtained with the Li-air flow battery. For 2-hour discharge rate, the maximum power will be 500 W. At a current density of 10 mA/cm², the size of the air electrode will be about 1.5 m² and the Li electrode will be about 750 cm². The weights of Li-ion reservoir and electrochemical reaction unit are about 2.3 kg and 0.54 kg, respectively.

Although the present invention has been described in considerable detail with reference to certain preferred versions thereof, other versions are possible. Therefore, the spirit and scope of the appended claims should not be limited to the description of the preferred versions contained herein.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C §112, sixth paragraph. In particular, the use of “step of” in the claims herein is not intended to invoke the provisions of 35 U.S.C §112, sixth paragraph.

What is claimed is:

1. An alkali metal-air flow battery system comprising an electrochemical reaction unit and an electrolyte reservoir,
the electrochemical reaction unit having an anode section and a cathode section and a alkali metal ion conductive membrane disposed between the anode section and the cathode section,
the anode section having
an anode comprising one or more alkali metals, and
an anode electrolyte chamber adjacent to the anode and the alkali
metal ion conductive membrane,
the cathode section having
an air electrode comprising porous carbon, and
a cathode electrolyte chamber adjacent to the air electrode and the alkali metal ion conductive membrane,
the electrolyte reservoir being fluidly coupled to the cathode electrolyte chamber to allow for circulation of an electrolyte solution from the electrolyte reservoir to the cathode electrolyte chamber.

2. The alkali metal-air flow battery system according to claim 1, wherein the one or more alkali metals is selected from the group consisting of including lithium (Li), sodium (Na), potassium (K), rubidium (Rb), caesium (Cs), francium (Fr), and combinations thereof.

3. The alkali metal-air flow battery system according to claim 1, wherein the one or more alkali metals is lithium.

4. The alkali metal-air flow battery system according to claim 1, wherein the electrolyte solution comprises a salt selected from the group consisting of diluted lithium hydroxide (LiOH), Acetic acid (CH₃COOH), Chloric Acid (HClO₃), Perchloric acid (HClO₄), Formic acid (HCOOH), Nitric acid (HNO₃), Salicylic acid (C₆H₄(OH)COOH), Sulfuric acid (H₂SO₄), Hydrobromic acid (HBr), Hydrochloric acid (HCl), Thiocyanic acid (HSCN), and combinations thereof.

5. The alkali metal-air flow battery system according to claim 1, wherein the electrolyte solution comprises diluted LiOH.

6. The alkali metal-air flow battery system according to claim 1, wherein the one or more alkali metals is lithium and the electrolyte solution comprises diluted LiOH.

7. The alkali metal-air flow battery system according to claim 1, wherein a thickness of the air electrode can be thicker than an oxygen diffusion length, expressed as:
$$λ = 2 F {ɛ}^{1.5} \frac{{c}_{{O}_{2}}^{0} {D}_{{O}_{2}}}{I}$$
where, ε is a porosity of the air electrode, c_{O}_{₂}⁰ is an oxygen concentration in the electrolyte solution near the air electrode, D_{O}_{₂} is an effective diffusion constant of the oxygen, and I is a discharge current density.

8. The alkali metal-air flow battery system according to claim 1, wherein a thickness of the air electrode is from 10 microns to 1 cm.

9. The alkali metal-air flow battery system according to claim 1, wherein an electrocatalyst is distributed at a surface of the one or more air electrodes.

10. The alkali metal-air flow battery system according to claim 9, wherein the electrocatalyst comprises α-MnO₂ nanoparticles in the cathode electrode.

11. A method of operating an alkali metal-air flow battery system comprising an electrochemical reaction unit and an electrolyte reservoir,
the electrochemical reaction unit having a lithium ion conductive membrane disposed between an anode section and a cathode section,
the anode section having
an anode comprising one or more alkali metals, and
an anode electrolyte chamber adjacent to the anode and the lithium ion conductive membrane,
the cathode section having
an air electrode comprising porous carbon, and
a cathode electrolyte chamber adjacent to the air electrode and the lithium ion conductive membrane,
the electrolyte reservoir being fluidly coupled to the cathode electrolyte chamber,
the method comprising circulating an electrolyte solution from the electrolyte reservoir to the cathode electrolyte chamber.

12. The method of claim 11, further comprising re-circulating the electrolyte solution from the cathode electrolyte chamber to the electrolyte reservoir.

13. The method of claim 11, wherein the method comprising circulating the electrolyte solution from the electrolyte reservoir to the cathode electrolyte chamber at a rate sufficient to maintain the solubility of at least one discharge product of a reaction occurring in the cathode section in the electrolyte solution.

14. The method of claim 11, wherein, during a discharge process of the alkali metal-air battery system, the method comprises circulating the electrolyte solution from the electrolyte reservoir to the cathode electrolyte chamber at a rate determined by a relationship between a current produced by the electrochemical reaction unit and an alkali metal-ion concentration in the electrolyte reservoir.

15. The method of claim 14, wherein the relationship is given by an expression:
$$Flow rate {\vert}_{discharge} = \frac{I}{F ( {m}_{sol} - m )} ,$$
where, I is the current, F is the Faraday constant, which is 96,485 C/mol, mₛₒₗ is the maximum molar concentration (solubility) of the electrolyte, and m is the molar concentration of the alkali metal-ion in the electrolyte reservoir.

16. The method of claim 11, wherein, during a charging process of the alkali metal-air battery system, the method comprises circulating the electrolyte solution from the electrolyte reservoir to the cathode electrolyte chamber at a rate determined by an expression:
$$Flow rate {\vert}_{charge} = \frac{I}{Fm} ,$$
where, I is the current, F is the Faraday constant, which is 96,485 C/mol, and m is the molar concentration of the alkali metal-ion in the electrolyte reservoir.

17. A method comprising flowing an electrolyte solution across an air electrode of a alkali metal-air battery.

18. The method of claim 17, wherein the electrolyte solution comprises diluted LiOH and the alkali metal is lithium.

19. The method of claim 18, wherein the flowing is done at a flow rate sufficient to maintain the concentration of LiOH in the electrolyte solution at less than 12.5 g of LiOH per 100 g of water.

20. The method of claim 19, wherein the flowing collects LiOH discharge product formed at the air electrode.
